(19) United States
(12) Patent Application Publication
(10) Pub. No.: US 2011/0188742 A1
(43) Pub. Date: Aug. 4, 2011

(54) RECOMMENDING USER IMAGE TO SOCIAL NETWORK GROUPS

(76) Inventors: Jie Yu, Rochester, NY (US); Dhiraj Joshi, Rochester, NY (US); Jiebo Luo, Pittsford, NY (US)

(21) Appl. No.: 12/698,490

(22) Filed: Feb. 2, 2010

(51) Int. Cl. G06K 9/62; G06K 9/46

(52) U.S. Cl. 382/159; 382/190; 382/224

(57) ABSTRACT

A method of recommending social group(s) for sharing one or more user images, includes using a processor for acquiring the one or more user images and their associated metadata; acquiring one or more group images from the social group(s) and their associated metadata; computing visual features for the user images and the group images; and recommending social group(s) for the one of more user images using both the visual features and the metadata.

### FIELD OF THE INVENTION

The present invention relates to automatically recommending user images to suitable groups in photo sharing and social network services.

### BACKGROUND OF THE INVENTION

Recent years have witnessed an explosive growth in media sharing and social networking on the Internet. Popular websites, such as YouTube, Flickr and Facebook, today attract millions of people. Tremendous effort has been spent on expanding social connection between users such as contacts. For example, U.S. Patent Application Publication No. 2008/0059576 provides a method and system for recommending potential contacts to a target user. A recommendation system identifies users who are related to the target user through no more than a maximum degree of separation. The recommendation system identifies the users by starting with the contacts of the target user and identifying users who are contacts of the target user's contacts, contacts of those contacts, and so on. The recommendation system then ranks the identified users, who are potential contacts for the target user, based on a likelihood that the target user will want to have a direct relationship with the identified users. The recommendation system then presents to the target user a ranking of the users who have not been filtered out.

Recently, special interest groups (SIG) or group(s) have become another very popular form of social connection in social network and media sharing websites. The phrase “group” is intended to include the social sub-community where two or more humans that interact with one another, accept expectations and obligations as members of the group, and share a common identity. Characteristics shared by members of a group include interests, values, ethnic or social background, and kinship ties. In this invention, the group is characterized by one or more commonly shared interests of its members. In such groups, the interactions naturally involve sharing pictures and videos of or related to the topics of interest. Within a large social network, contributing images to one or more interest groups is expected to greatly promote the personal social interactions of users and expand their personal social networks. Therefore, many users view it as a desirable activity to share their assets in one or more interest groups.

From a user's point of view, manually assigning each photo to an appropriate group is tedious, which requires matching the subject of each image with the topic of various interest groups. Automating this process involves understanding the image content of user images and images from all available groups. Traditional methods of automatic recommendation can not solve the group recommendation problem because they can only recommend items to one specific user, not a group of users who shared common interest. For example, U.S. Pat. No. 6,064,980 assigned to Amazon.com describes a recommendation service that uses collaborative filtering techniques to recommend books to users of a website. The website includes a catalog of the various titles that can be purchased via the site. The recommendation service includes a database of titles that have previously been rated and that can therefore be recommended by the service using collaborative filtering methods. At least initially, the titles and title categories (genres) that are included within this database (and thus included within the service) are respective subsets of the titles and categories included within the catalog. As users browse the website to read about the various titles contained within the catalog, the users are presented with the option of rating specific titles, including titles that are not currently included within the service. The ratings information obtained from this process is used to automatically add new titles and categories to the service. The breadth of categories and titles covered by the service thus grows automatically over time, without the need for system administrators to manually collect and input ratings data. To establish profiles for new users of the service, the service presents new users with a startup list of titles, and asks the new users to rate a certain number of titles on the list. To increase the likelihood that new users will be familiar with these titles, the service automatically generates the startup list by identifying the titles that are currently the most popular, such as the titles that have been rated the most over the preceding week.

Recently, researchers have proposed the use of contextual information, such as image annotations, capture location, and time, to provide more insight beyond the image content. Negoescu and Perez analyzed the relationships between image tags and groups in their published article of Analyzing Flickr Groups, Proceedings of ACM CIVR, 2008. They further propose to cluster the groups using image tags in the same group. Chen et al. tried to solve that problem from a content analysis perspective in their published article of SheepDog: Group and Tag Recommendation for Flickr Photos by Automatic Search-Based Learning, Proceedings of ACM Multimedia, 2008. Their system first predicts the related categories for a query image and then search for the most related group. In that sense, it only uses the visual content of the images. Overall, an approach that exploits the affinity among images in a collection and complementary information in image content and the associated context for group recommendation has not been reported in the literature.

### SUMMARY OF THE INVENTION

In accordance with the present invention, a method of recommending social group(s) for sharing one or more user images, comprising:

using a processor for

(a) acquiring the one or more user images and their associated metadata;

(b) acquiring one or more group images from the social group(s) and their associated metadata;

(c) computing visual features for the user images and the group images; and

(d) recommending social group(s) for the one of more user images using both the visual features and the metadata.

Features and advantages of the present invention include: (1) using both image content and multimodality metadata associated with image to achieve a better understanding of user and group images; (2) calculating the affinity among a collection of user images to collectively infer user interests; (3) using the collection affinity, image visual feature and associated metadata to suggest the suitable social groups for user images; and (4) selecting the influential image(s) in the collection, based on the collection affinity, for relevance feedback to further improve group suggestion accuracy.

### BRIEF DESCRIPTION OF THE DRAWINGS

FIG. 1 is overview of a system that can make use of the present invention;

FIG. 2 is a pictorial representation of a processor;

FIG. 3 is a flow chart for practicing an embodiment of the invention;

FIG. 4 shows by illustration the group images; and

FIG. 5 shows by illustration the extracted visual feature and metadata.

### DETAILED DESCRIPTION OF THE INVENTION

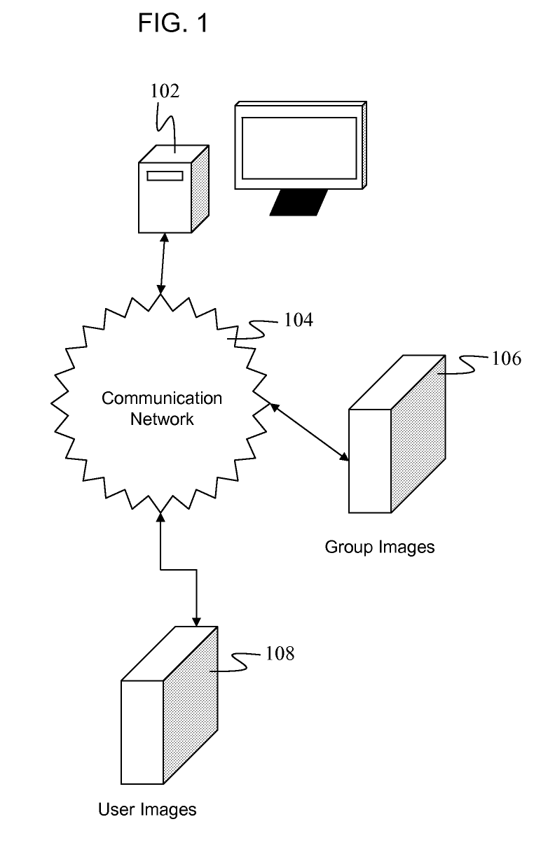

FIG. 1 illustrates an overview of the system with the elements that practice the current invention including a processor 102, a communication network 104, a group image 106, and a user image collection 108.

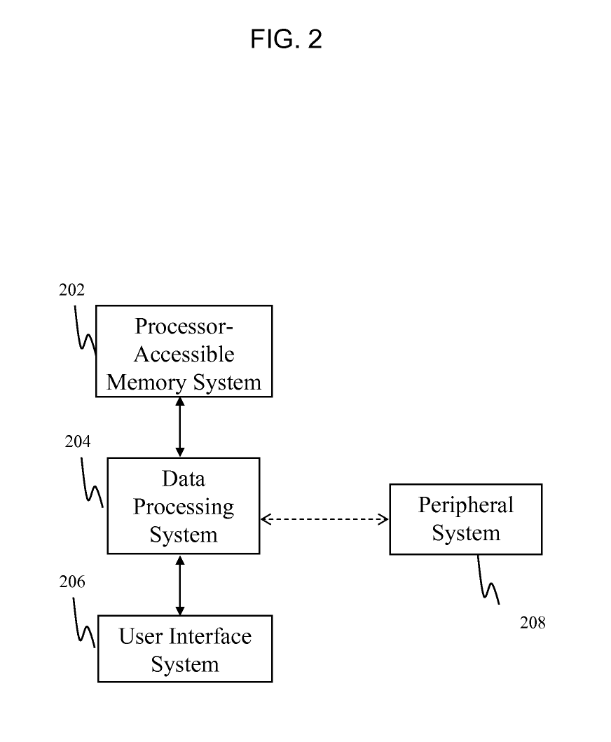

FIG. 2 illustrates a processor 102 and its components. The processor 102 includes a data processing system 204, a peripheral system 208, a user interface system 206, and a processor-accessible memory system 202.

Processor 102 obtains the user image collection 108 using peripheral system 208 from a variety of sources (not shown) such as digital cameras, cell phone cameras, and user account on photo-sharing websites, e.g. Kodak Gallery. Multiple users contribute to and share their images in special interest groups, which contain the group images 106 on photo-sharing websites. These group images 106 on the photo-sharing websites and user image collection 108 are collected through communication network 104.

Processor 102 is capable of executing algorithms that make the group suggestion using the data processing system 204 and the processor-accessible memory system 202. It can also display the group suggestion to and interact with user for relevance feedback via user interface system 206.

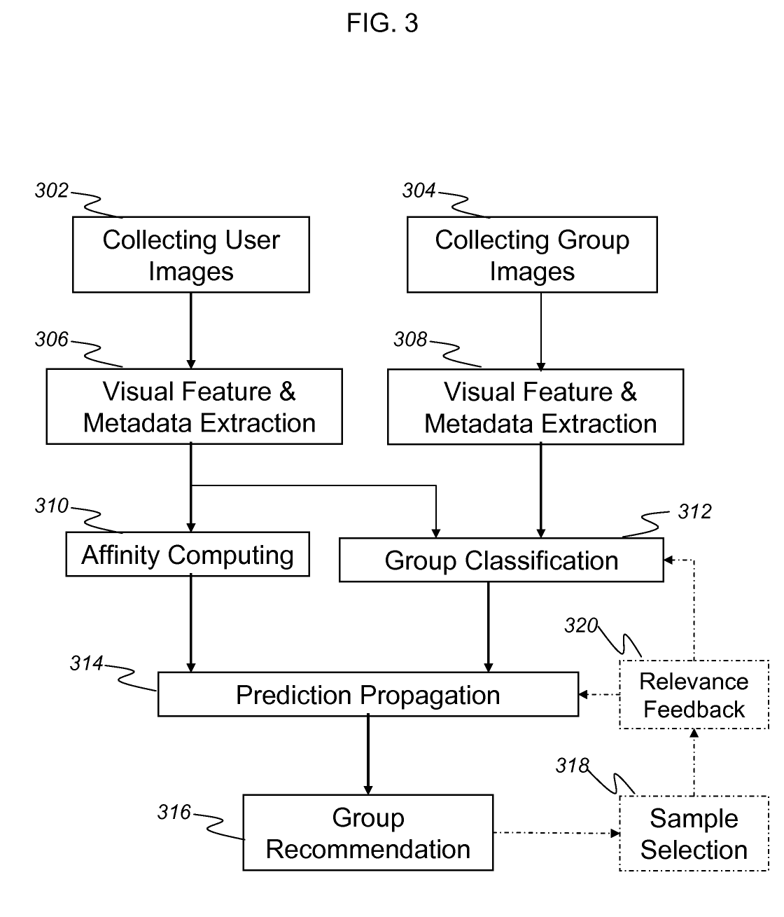

FIG. 3 illustrates the diagram of the group suggestion method that was executed in the processor 102.

In step 302, a collection of user image collections 108 that need group suggestion are collected. The user can cluster images into collections by events, subjects depicted in the pictures, capture times, or locations. The user can also group all the images he/she owns as a collection. The collection of user image collections 108 is obtained from a personal computer, a capturing devices such as camera and a cell phone, or in user's photo-sharing web accounts.

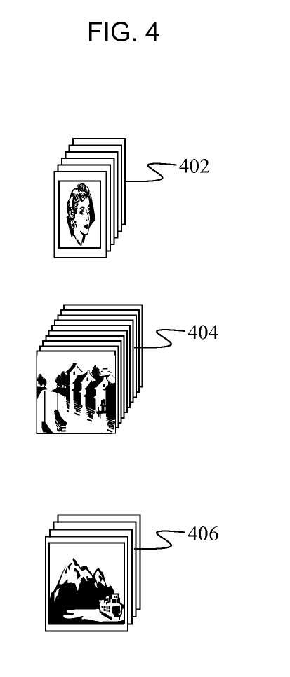

In step 304, group images that are from a set of per-defined groups are collected. The pre-defined groups are selected from common interest themes or are defined by user. FIG. 4 shows, by illustration, examples of images from group of people 402, architecture 404 and nature scene 406, respectively. The group images 106 are contributed by multiple users for sharing in the groups on photo-sharing websites such as Flickr. Collecting group images 106 involves downloading and storing all or a subset of images in the pre-defined groups.

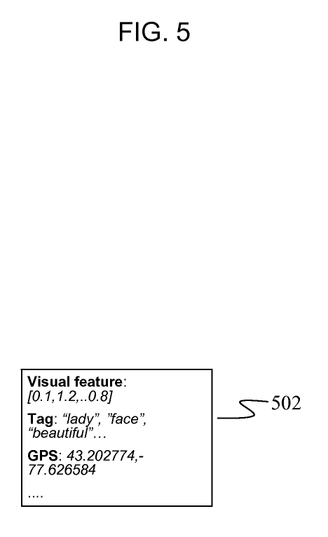

In steps 306 and 308, visual feature and associated metadata are extracted from user image collection and group images. The phrase “image metadata” or “metadata” is intended to include any information that is related to a digital image. It include text annotation, geographical location (where the photo is taken), camera settings, owner profile and group association (which group is has been contributed to). The phrase “visual features” is intended to include any visual characteristics of a digital image that are calculated through statistical analysis on its pixel values. FIG. 5 shows, by illustration, examples of extracted visual features and metadata 502 for images.

The widely used visual feature includes color histogram, color moment, shape and texture. Recently, many people have shown the efficacy of representing an image as an unordered set of image patches or “bag of visual words” (F.-F. Li and P. Perone, A Bayesian hierarchical model for learning natural scene categories, Proceedings of CVPR, 2005; S. Lazebnik, C. Schmid, and J. Ponce, Beyond bags of features: spatial pyramid matching for recognizing natural scene categories, Proceedings of CVPR, 2006). Suitable descriptions (e.g., so called SIFT descriptors) are computed for each of training images, which are further clustered into bins to construct a “visual vocabulary” composed of “visual words”. The intention is to cluster the SIFT descriptors into “visual words” and then represent an image in terms of their occurrence frequencies in it. The well-known k-means algorithm is used with cosine distance measure for clustering these descriptors.

Some metadata such as GPS coordinates of where the image was taken can be converted into vector format directly. User annotation often contains important insight about the subject of an image. Statistical analysis, such as probabilistic Latent Semantic Indexing (pLSI) and Latent Dirichlet Allocation (LDA), have been used successfully in extracting semantic topics out of free text. Different from other methods in natural language processing, they model the words in articles as being generated by hidden topics. One can use LDA to extract the hidden topics in an annotation set and use the estimated topic assignments for each word to form a vector, which represents the image in the compact topic space.

In step 312, the visual features and metadata of user image collection 108 and group images are used to train a group classifier and make initial group suggestions for each image in the user image collection 108 independently.

The group images 106 are contributed by users to one or multiple group(s) from the pre-defined group set. They are treated as associated with corresponding groups and used to train one or multiple classifier(s). The phrase “classifier” is intended to include any statistical learning process which individual images are recommended into social groups based on visual features, metadata, and a training set of previously labeled images. The images from the user image collection 108 are used as testing data. Given an image from user image collection 108, the classifier(s) will generate confidence-rated scores on if the image is associated with one or multiple group(s). Classification methods, such as Support Vector Machine, Boosted Tree and Random Forest, can be readily plugged into this framework to learn the subjects of different group categories.

The visual features and associated metadata of the image often contain complementary information. In this invention, they are fused in the classification process. Fusion of such multiple modalities can be conducted at three levels: 1) feature-level fusion requires concatenation of features from both visual and textual descriptors to form a monolithic feature vector; 2) score-level fusion often uses the output scores from multiple classifiers across all of the features and feeds them to a meta-classifier; and 3) decision-level fusion trains a fusion classifier that takes the prediction labels of different classifiers for multiple modalities.

In step 310, the affinity scores between any pair of images in the user's image collection 108 are calculated. The phrase “affinity score” or “affinity” is intended to describe the pair-wise relationship between any two images in the user image collection 108. The affinity scores represent reconstruction relationship or similarity of two images in the collection. By modeling the images as nodes in a graph and affinity scores as pair wise edge weights, the affinity matrix of the collection is obtained. The affinity matrix can be calculated as in manifold learning techniques, such as Locally Linear Embedding and Laplacian Eigenmap. For example, let xᵢ denote the images in a collection, the affinity matrix W can be solved by the following minimization problem:

$$min {\sum }_{i} {‖ {x}_{i} - {\sum }_{j \neq i} {w}_{ij} {x}_{j} ‖}^{2} \qquad ( 1 )$$

The calculation can be conducted using visual features alone, metadata alone or the concatenation of both visual feature and metadata.

Researchers found that human vision system interprets images based on the sparse representation of the visual features. A sparse W does not make the local distribution assumption and provides an interpretive explanation of the correlation weights. Practically, the shrinkage of coefficients in combining predictors often improves prediction accuracy. Although solving for the sparsest W is NP-hard, it can be approximated by the following convex l₁-norm minimization:

$$\begin{matrix}min {\sum }_{i} {‖ {x}_{i} - {\sum }_{j \neq i} {w}_{ij} {x}_{j} ‖}^{2} + γ {\sum }_{i , j} \vert {w}_{ij} \vert & ( 2 ) \\ or & \\ min {\sum }_{i} {‖ {x}_{i} - {\sum }_{j \neq i} {w}_{ij} {x}_{j} ‖}^{2} s . t . {\sum }_{i , j} \vert {w}_{ij} \vert < s & ( 3 )\end{matrix}$$

where γ and s are constant.

Solving the above optimization equation (3) forms a quadratic programming problem. This optimization problem could be solved by several algorithms. Examples in clued LASSO, introduced by R. Tibshirani in the published article Regression shrinkage and selection via the lasso (J. Royal. Statist. Soc B., Vol. 58, No. 1, pages 267-288), and modified Least Angle Regression introduced by Efron et al. in the published article Least angle regression (Annals of Statistics, 2003).

In step 314, the initial group suggestion from step 312 is refined by prediction based on affinity matrix from step 310.

The initial group prediction for the user image collection 108 from step 312 is denoted as γ⁰. It is reasonable to assume that similar images from the same user's image collection 108 should have similar predictions. Therefore, the prediction of one image can be propagated to its similar ones from the same user image collection 108. For example, the propagation can be set up in the following iterative process:

Y^{t+1}=(1−Λ)W·Y^{t}+ΛY⁰ (4)

W is the affinity matrix obtained from step 310, which described the similarity between images. Λ is a matrix that regulates how the refined prediction can be learned from other samples. It can be defined in the following way:

$${λ}_{i , j} = \{ \begin{matrix}max \frac{{y}_{i , j}^{0}}{{\sum }_{j} {y}_{i , j}^{0}} & i = j \\ 0 & i \neq j\end{matrix} \qquad ( 5 )$$

where y_{i,j}⁰ is the initial prediction of sample xᵢ for group j from step 312.

The final prediction Y^{t} for images would be refined by iterating equation (4) until convergence.

In step 316, the group suggestion for each image in the user's image collection 108 is the group(s) with the highest score or above certain threshold.

In optional step 318, the system select one or multiple samples, based on their influence on other samples in the collection, obtain relevance feedback from user. In image understanding systems, relevance feedback is often used to improve the prediction accuracy by selecting one or multiple samples and asking user to provide ground truth label information. However, labeling many samples for relevance feedback is impractical due to the human effort involved. It is critical to select sample(s) that would improve the performance improvement with limited relevance feedback from users. Existing relevance feedback methods do not fully exploit the relationship between samples within the same collection.

The affinity matrix of the collection is used to select the informative and influential samples, which would improve the prediction enhancement from user feedback.

Suppose the user provides feedback that image r is from group l, the change in prediction matrix is denoted as RF_{r,l} and the new prediction as Y^{t}+RF_{r,l}.

Evidently, the i-th row of regulation matrix Λ^{r} needs to be updated as follows:

$${λ}_{r , j} = \{ \begin{matrix}1 & j = r \\ 0 & for other j\end{matrix} \qquad ( 6 )$$

The new labels can be propagated to the rest in the collection as follows:

Y^{RF}^{_{r,l}}=(1−Λ)(1−ΛW)⁻¹(Y^{t}+RF_{r,l}) (7)

Intuitively, relevance feedback should select the optimal sample that would maximize the change in the refined prediction. Such an optimization problem can be formulated as follows:

$$r = {arg max}_{r} {\sum }_{l} P ( l ) P ( r \vert l ) ‖ {Y}^{{RF}_{r , l}} - {Y}^{t} ‖ \qquad ( 8 )$$

P(r|l) is the probability of that sample r is from class l and can be approximated by the prediction confidence of classifier:

$$P ( r \vert l ) \approx \frac{{y}_{r , l}^{t}}{{\sum }_{l} {y}_{r , l}^{t}} \qquad ( 9 )$$

The optimal sample for relevance feedback can be determined using (8) in O(N*L) where N is the number of images in the collection and L is the number of classes.

In optional step 320, the system presents the selected sample(s) and present to user. User would provide the ground truth information about which group(s) the sample(s) belong to.

Alternatively, the system uses user feedback to update the refined prediction, set the updated prediction as initial prediction, and repeat from step 314 without retraining the classifier(s). Alternatively, it goes to step 312, which adds the newly labeled images to the training set to retrain the classifier(s), and repeat. This iterative process would end when user is satisfied or certain number of iterations is met.

The various embodiments described above are provided by way of illustration only and should not be construed to limit the invention. Those skilled in the art will readily recognize various modifications and changes that can be made to the present invention without following the example embodiments and applications illustrated and described herein, and without departing from the true spirit and scope of the present invention, which is set forth in the following claims.

### PARTS LIST

102 processor
104 communication network
106 group images
108 user image collections
202 processor-accessible memory systerm
204 data processing system
206 user interface system
208 peripheral system
302 collecting user images step
304 collecting group images step
306 visual feature and metadata extraction step
308 visual feature and metadata extraction step
310 affinity computing step
312 group classification step
314 prediction propagation step
316 group recommendation step
318 sample selection step
320 relevance feedback step
402 examples of people group images
404 examples of building group images
406 examples of natural scene group images
502 examples of visual feature and metadata

1. A method of recommending social group(s) for sharing one or more user images, comprising:
using a processor for
(a) acquiring the one or more user images and their associated metadata;
(b) acquiring one or more group images from the social group(s) and their associated metadata;
(c) computing visual features for the user images and the group images; and
(d) recommending social group(s) for the one of more user images using both the visual features and the metadata.

2. The method of claim 1 wherein the metadata includes photographer, taken time, taken location, or user annotations.

3. The method of claim 1 wherein the social groups include flower, animal, architecture, beach, sunset/sunrise, or portrait.

4. The method of claim 1 wherein step (d) further comprises:
(i) using a classifier to provide an initial recommendation of social groups for the user images based on the visual feature and metadata;
(ii) computing affinity between the user images using both the visual feature and metadata; and
(iii) using a propagation technique to refine the initial recommendation of social groups for the user images based on the affinity.

5. The method of claim 4, wherein step (ii) computing affinity between user images includes constructing an affinity matrix using visual features, metadata or the combination of visual features and metadata.

6. The method of claim 4, wherein step (iii) includes using a propagation technique refines the recommendations of one image by propagating recommendations from the other images weighted by the pair-wise affinity scores in the affinity matrix.

7. The method of claim 4, wherein step (d) further comprises:
(iv) selecting samples based on refined group recommendation and image affinity;
(v) presenting the samples to user and obtaining relevance feedback from user about the correct group recommendation for the samples;
(vi) using the user relevance feedback to update the initial group recommendation; and
(vii) repeating steps (d) (iii), (d) (iv) through (d) (vi) until the user is satisfied.

8. The method of claim 4, wherein step (d) further comprises:
(iv) selecting samples based on refined group recommendation and image affinity;
(v) presenting the samples to user and obtaining relevance feedback from user about the correct group recommendation for the samples;
(vi) using the user relevance feedback to retrain the classifier;
(vii) using the retrained classifier to provide an improved initial recommendation of social groups for the user images based on the visual feature and metadata; and
(viii) repeating steps (d) (iii), (d) (iv) through (d) (vii) until the user is satisfied.
